(19) United States
(12) Patent Application Publication
(10) Pub. No.: US 2006/0018625 A1
(43) Pub. Date: Jan. 26, 2006

(54) User defined default recording mode rules

(76) Inventors: Carolynn Rae Johnson, Indianapolis, IN (US); Gavin Lee Johnston, Indianapolis, IN (US)

Correspondence Address: THOMSON LICENSING INC., PATENT OPERATIONS, PO BOX 5312, PRINCETON, NJ, 08543-5312, US

(21) Appl. No.: 10/894,953

(22) Filed: Jul. 20, 2004

(51) Int. Cl. H04N 5/76

(52) U.S. Cl. 386/46; 386/83

(57) ABSTRACT

A method and apparatus are disclosed for providing user selectable default recording modes in a recording device. The present invention relates to a method and apparatus for determining a default recording mode comprising the step of defining at least one default recording mode rule to be applied across a plurality of video recording sessions.

### FIELD OF THE INVENTION

The present invention generally relates to video recording devices, and more particularly to systems and methods for managing storage space of video, storage devices based on recording modes.

### BACKGROUND OF THE INVENTION

Conventional Digital Versatile Disks (DVD), and other digital video recorders provide user-selectable recording modes. Each recording mode corresponds to a recording quality. For example, in one type of conventional system High Quality (XP) mode typically provides the highest quality recording with the shortest recording time. Standard Play (SP) mode provides the next highest quality recording but a longer recording time. Long Play (LP) and Extra Long Play (EP) recording mode yields more recording time than SP mode but lower quality. It should be noted that different manufacturers use different acronyms to describe different modes, i.e., various combinations of play time and quality. Not all of these definitions are consistent. Regardless of a particular terminology, managing the trade off between recording quality and play time (storage space) is important to many users.

To that end, some conventional systems further include a flexible Recording (FR) mode. A FR mode records with the best picture quality possible for the recording time and remaining space on the disc. Table 1 illustrates one example of a conventional relationship between recording mode, recording times (duration), and recording data rate.

TABLE 1

| | Recording Times | | | |
|---|---|---|---|---|
| | 4.7 GB Discs | 9.4 GB Discs | Data Rates | |
| XP High quality recording mode | about 1 hour | about 2 hours | about 10 | Mbps |
| SP Standard recording mode | about 2 hours | about 4 hours | about 5 | Mbps |
| LP Long recording mode | about 4 hours | about 8 hours | about 2.5 | Mbps |
| EP Extra long recording mode | about 6 hours | about 12 hours | about 1.7 | Mbps |

| | | |
|---|---|---|
| FR Flexible recording mode | 60 to 360 min. (4.7 GB) | 1.7 Mbps-10 Mbps |

Conventional recorders include recording timers. Recording timers of both the manual and automatic types are available. A recording timer is manually set, for example, by a user depressing a “record” button at the time recording is desired. Likewise, a recording timer is manually terminated by a user depressing a “stop”, or like, button on the recording device or via remote control. Typical recording timers further allow a user to start recording and stop recording automatically based upon the occurrence of an “event”. As used herein the term “event” refers to any cue suitable for initiating or terminating recording. For example, conventional timers are set by a user to start recording at a particular time of day and to stop recording at another time of day. In another typical example, timers are settable to start recording at the start of a particular program. The following are further examples of events upon which recording actions are typically based: time of day, tuning to a particular channel, start and stop of a particular program. The term “session”, as defined herein, refers to the time between a recording start event and a subsequent recording stop event. The term session is applied herein to both manual and automatic recording timers.

A number of existing systems enable a user to define a recording mode specific to a corresponding recording timer. However, in the case of a user failing to select a recording mode corresponding to a timer, a system-defined default recording mode is typically applied to the recording session for that timer. As used herein the term “default recording mode” refers to a recording mode applied by a recording device in the absence of a timer-specific recording mode. Thus, a system defined default mode may not match a user's preferences for programming quality for those timers lacking timer specific recording modes. This mismatch is more likely to occur as the number of timers set by a user increases. Many users find it burdensome to set a recording mode each time the user sets a timer.

Some recording devices have FR (Flexible Recording) modes that automatically vary the recording quality to get the best available picture based upon the total amount of recording in that session. A user typically cannot interact with the quality settings of such devices while in the FR mode. Therefore, a user has little control over recording modes selected on the basis of total recording time remaining. The modes selected may not match a user's preferences.

From a user perspective, existing systems and methods have a common drawback. That is, user options for controlling recording mode, i.e., quality, of recordings of received programs are limited. The first option is to set a desired recording mode for each corresponding individual recording timer. This is often burdensome and time consuming to the user. The second option is to select a recording mode for at least one individual timer, but not to set recording modes for other timers. In that case a system default recording mode is typically applied to the other timers. The third option is to accept the default recording mode for all timers. Some conventional systems allow a user to set a single default recording mode. However, that user selected default mode is the same for all timers without timer specific recording modes. Accordingly, all sessions recorded by system defaults use the same system default recording mode.

Therefore, a need exists for systems and methods that allow a user to define rules for applying a default recording mode across a plurality of timers in accordance with a rule. Such systems would free the user from the task of setting a recording mode each time the user sets a timer.

### SUMMARY OF THE INVENTION

The present invention relates to a method and apparatus for determining a default recording mode comprising the step of defining at least one default recording mode rule to be applied across a plurality of video recording sessions.

### BRIEF DESCRIPTION OF THE DRAWINGS

Preferred embodiments of the present invention will be described below in more detail, with reference to the accompanying drawings, in which:

FIG. 1 is a flow chart of a method for providing user defined default recording mode rules according to an embodiment of the present invention.

FIG. 2 is flow chart that of a method determining recording mode to be applied when recording programming according to an embodiment of the invention.

FIG. 3 illustrates a television onscreen display presenting a list of available rules pertaining to levels of recording quality according to an embodiment of the invention.

FIG. 4 illustrates a television onscreen display showing a menu of selectable parameter types for identifying a class of multimedia according to an embodiment of the invention.

FIG. 5 illustrates a television onscreen display showing parameters identifying classes of multimedia according to an embodiment of the invention.

FIG. 6 illustrates a television onscreen display showing a data input screen associating a level of recording quality with an identified class of multimedia according to an embodiment of the invention.

FIG. 7 illustrates a television onscreen display showing a data input screen for identifying a recording rule according to an embodiment of the invention.

FIG. 8 is a block diagram of a recording device according to one embodiment of the invention.

### DETAILED DESCRIPTION

The present invention relates to a video recording system for applying a default recording mode in accordance with at least one user-defined default recording mode rule. A user-defined default recording mode rule is also referred to herein as a “default rule”. The user-defined default rule is applied across a plurality of recording timers without user intervention for each timer. Thus a default rule accounts for recording mode preferences of a user in determining present and future recording modes to apply to recording sessions in the absence of specific instructions for a timer.

According to an embodiment of the invention, a recording mode associated with a timer programming to be recorded is selected based upon at least one “program parameter”. As used herein the term “program parameter” refers to any program characteristic suitable for identifying a program. A processor accepts attribute information from a user.

In accordance with one embodiment of the invention, a user selects at least one program parameter upon which to base a user defined default rule. The user assigns a corresponding recording mode to be applied to programs having at least one parameter matching the selected parameter. When multimedia matching the attribute is recorded, if a corresponding session recording mode has not been defined, the default recording mode corresponding to the attribute is applied. Therefore, the default recording mode actually applied can differ from session to session in accordance with the rule.

Advantageously, this feature enables the optimization of storage space usage without need for the user to assign a recording mode each time the user sets a recording timer.

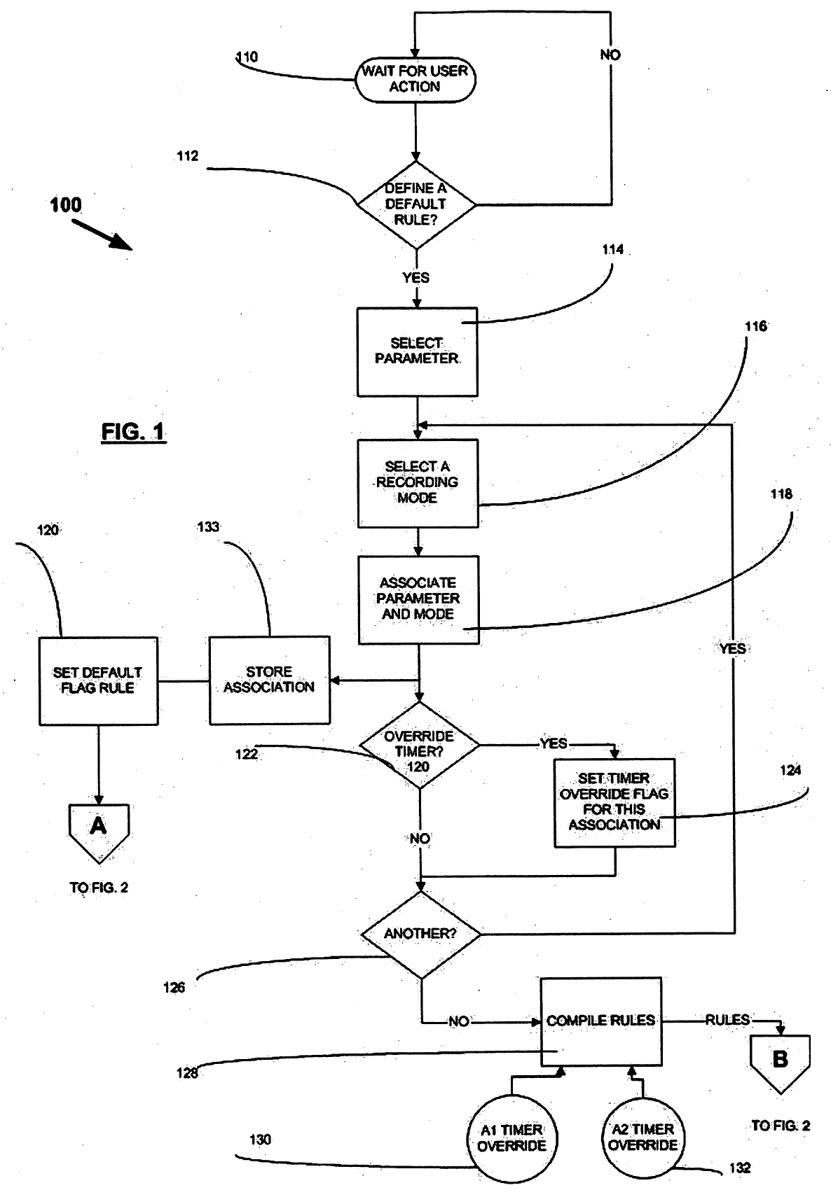

FIG. 1 is a flow chart representing steps for defining at least one default rule according to one embodiment of the invention. In operation, a system of the invention waits for user action to be detected at step 110. At step 112, a recording device, such as a personal video recorder (PVR), receives a user request to define a default recording mode rule. Defining a rule includes operations of adding a new default recording rule to existing default recording mode rules and to editing an existing default recording mode rule. For example, a user enters the request by initiating an action via a user interface (UI). Examples of suitable user interfaces include, but are not limited to, a graphical user interface (GUI), a text-based interface, etc. In one embodiment of the invention, the UI includes at least one display screen that is provided on a video display. Examples of suitable video displays include, but are not limited to, televisions, projection screens, computer monitors, and other video displays. The UI also includes a user input device. Suitable user input devices include a remote control unit, a keyboard, a mouse, and any other input device that can be used to enter user commands.

Upon detection of user action to define a default rule, the recording device proceeds to carry out step 114. Thereby, the recording device receives at least one user selected programming parameter via the UI. In an embodiment of the invention, an example UI displays a menu to a user. The displayed menu includes user-selectable programming parameters. The user selects at least one parameter from the menu via the UI. One example of a suitable parameter is a time of day. Other suitable parameters include, but are not limited to, a day of week, a multimedia content type, a television or movie rating associated with the multimedia content, a channel number, a channel type (e.g. a premium channel, a local channel, etc.) and any other identifier that can be used to characterize multimedia programming.

Continuing at step 116, the recording device receives from the user an indication of a recording quality, i.e., a user-selected default recording mode. In an embodiment of the invention, step 116 is carried out by a UI providing a menu to a user. The menu includes user-selectable recording modes. The user selects at least one of the recording modes from the menu via a user interface. It will be appreciated that any number of recording mode selections are suitable in keeping with the recording quality capabilities of a given recording device. According to one embodiment of the invention, recording mode selections range from low quality to high (or best) quality, having a plurality of levels in between. According to one embodiment of the invention, the number of levels is three, namely: lowest, average, and highest quality.

Next at step 118, the recording device associates the user-selected default recording mode as described above, with the at least one parameter selected as described above. In that manner, a default recording rule is defined by a user. According to an embodiment of the invention, means for a user to select a label, e.g., a name, an icon, or the like, for a rule is provided. Thus, rules are visually identifiable by a user during display, facilitating rule management. In one embodiment of the invention, rules are saved in a memory of the device, as per step 132. In one embodiment of the invention, rules saved in memory are applied in situations wherein the user did not set a corresponding recording mode when setting a timer. However, other embodiments of the invention include at least one user selectable option for at least one rule to override timer recording mode settings as indicated at 122. In that case, for received programs having matching rule parameters, recording modes set at the time of setting corresponding timers are ignored. Instead the recording rule mode is applied in this case.

Further embodiments of the invention include a step of compiling existing rules in order to eliminated rule redundancies and conflicts as indicated at step 128. One example of a rule conflict is the existence of a first rule applying a first recording mode based on start and stop time of day. At the same time, a second rule exists applying a second recording mode for timers based on rating. In that case it is possible for a single received program to satisfy both rules. In one embodiment of the invention step 128 includes steps of identifying such conflicts to a user and prompting a user for action to resolve rule conflicts. In one embodiment of the invention, rule compiler 128 accounts for rules identified as overriding timer set recording modes as indicated at 130 and 132 of FIG. 1.

In one embodiment of the invention, a user is prompted to resolve conflicts, for example, by selecting a conflict-resolving scheme. An example of one suitable conflict-resolving scheme is a precedence scheme. For example, a higher quality recording mode takes precedence over lower quality recording mode, and vice versa. Other conflict resolving schemes are suitable for use in accordance with the principals of the invention.

In one embodiment of the invention, rules are established to determine recording mode, wherein recording mode relates to recording quality. Other embodiments of the invention include rules applicable to determine other storage device management related operations. For example, rules pertaining to deleting multimedia content from a storage device are definable by a user according to some embodiments of the invention. Alternatively, new rules are established for such a purpose. For example, in one embodiment, rules are established to delete multimedia content from a specific genre after a first time period. Multimedia content from another genre is deleted after a second time period. Alternatively, the multimedia content remains on the storage device until manually deleted. Rules are definable in accordance with the principles of the invention for these other system operations as well.

Therefore, an embodiment of the present invention provides means for varying device operation, for example, recording mode, according to a users general preferences in relation to program parameters, and in accordance with at least one user defined rule.

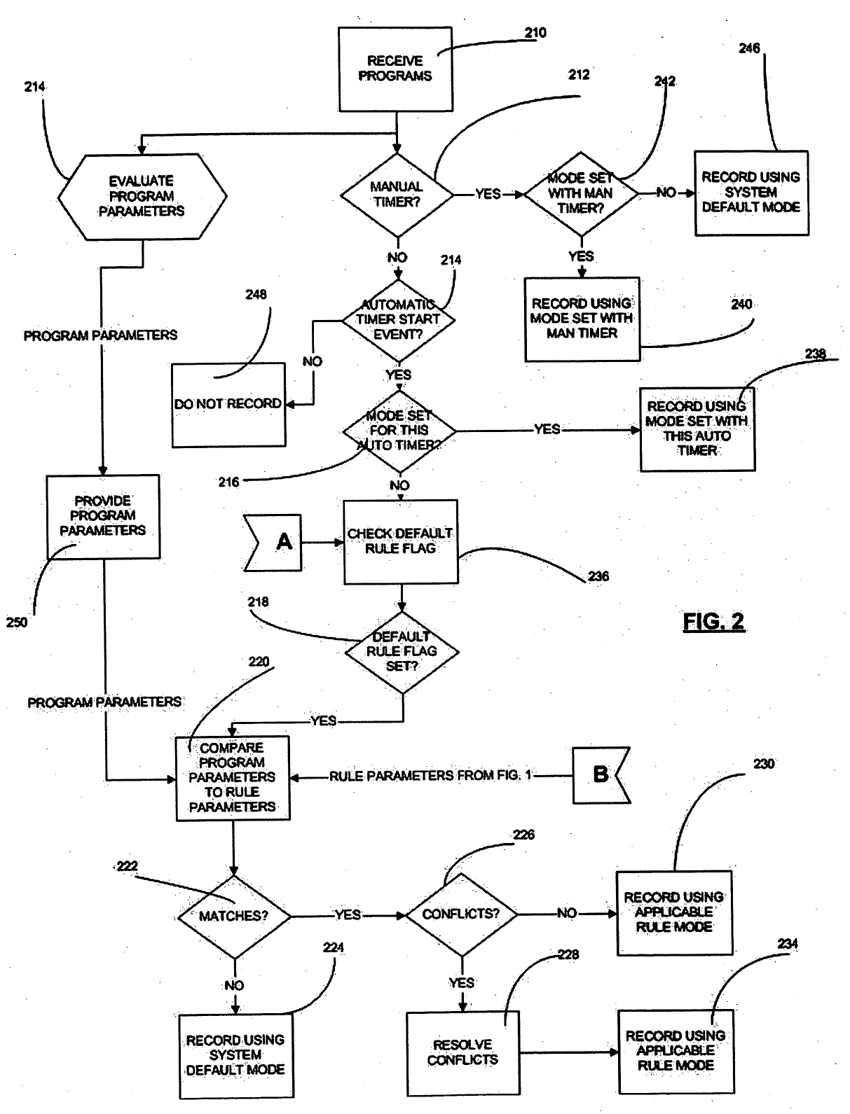

FIG. 2 presents a method 200 for applying a default recording mode rule according to an embodiment of the invention. The method automatically determines a recording mode for recording multimedia received by the recording device. Beginning at step 210, a receiver receives programming. According to various embodiments of the invention, programming is received from the group comprising: broadcast programming, cable programming, satellite programming, and programming received via the Internet. At step 214, the recording device evaluates at least one parameter associated with received programming in order to provide parameter information at step 250 for recording mode decision-making.

For example, if a recording mode is based upon a time of day parameter, the recording device provides a time of day the multimedia is received. This information is used for recording mode decision-making. In that case, a recording mode decision is based upon a comparing step 220, comparing received time of day to the time of day specified by a rule parameter.

Step 212 governs manual timers. When a user sets a manual timer, some recording devices simultaneously provide an option for selecting recording mode with the manual timer as indicated at step 242. If a user sets a recording mode with a manual timer, that recording mode is used to record the selected programming as indicated at step 240. The case of a user declining to set a recording mode is illustrated at step 243. Step 243 determines if a user defined default recording mode exists that is applicable to the programming subject to the manual timer. If a user default recording mode is applicable, the user default recording mode is applied as indicated at step 244. In the absence of an applicable user defined default recording mode, a system default recording mode is applied to the programming subject to the timer. This is illustrated at step 245.

Proceeding to step 214, the system detects an occurrence of an automatic timer start event. Such events are those typically available on conventional recording systems for setting recording timers. Examples of such events include, time of day, tuning to a channel, program name, and the like. In one embodiment of the invention, in the event no automatic timers are set, and no manual timers are initiated, no recording takes place. According to other embodiments of the invention, user defined default rules are applied to received programming so as to initiate recording in accordance with the rule even in the absence of automatic timers.

Referring to step 216, when an automatic timer is set, and a timer start event occurs as in step 214, the system determines an applicable recording mode in accordance with the invention. In the embodiment illustrated in FIG. 2, if a recording mode was set with the automatic timer, that set mode is used to record the programming in accordance with the timer, regardless of user defined default recording mode rules. According to an alternative embodiment of the invention, for each definition of a user defined default recording rule, a user is provided with an option for overriding timer recording mode rules. This embodiment is described in FIG. 1 at steps 133 and 135. Accordingly, if a recording mode was set with a timer, and an active default recording mode rule also applies to programming associated with that timer, and a timer override was indicated for the active default recording mode rule, the default recording mode rule overrides the timer defined recording mode. The system records with the user-defined default recording mode as per the rule.

However, if no recording mode was set with the timer, the system proceeds to step 236 to determine at least one user-defined default recording mode rule is presently activated. In one embodiment of the invention, a default recording mode rule flag is set when user-defined default recording modes are stored and activated. This is further illustrated in FIG. 1 at steps 132, 135 and tab A. The flag is cleared in the absence of stored user-defined default recording mode rules. The flag is cleared when no stored default recording mode is active. This is the case, for example, when a user deactivates a rule via a UI. It will be readily appreciated by those of ordinary skill in the art, that other determining techniques are suitable for use to determine the presence and status of stored conditions and information. If the system determines at step 218 that no default recording rule is active, (no mode was set with the timer as per step 216) the system records the programming in accordance with the timer using a system default recording mode.

Regardless of the determining means employed, when it is determined at step 218 that at least one user defined default rule is active, a comparison step is carried out as per step 220. The parameters for presently received programming are compared to rule parameters (indicated at tab B) to determine if matches exist as indicated by step 222. If no match exists, a system default recording mode is used to record the incoming programming as per step 224.

If a match exists, a user defined default recording rule corresponding to the matching parameter governs the recording mode for the received programming as per step 230. In one embodiment of the invention illustrated in FIG. 2, a rule conflict-resolving step is carried out as per steps 226 and 228 in some embodiments of the invention conflict resolving steps are carried out in case a parameter of the received programming matches more than one recording mode according to active user defined default recording mode rules. In that case, the system carries out a conflict resolving step 228 in order to determine which of the more than one user defined default recording mode rules is to be applied to the received programming as per step 234. Various embodiments of the invention will apply various conflict resolving techniques. Some embodiments will provide user operable means for defining rule precedence at the time a user defines default recording mode rules. Other embodiments of the invention automatically identify conflicting user defined default recording mode rules and provide a corresponding indication to the user. In one embodiment, the system will prompt the user to take action to resolve the conflict. Other embodiments will automatically select the highest quality recording mode of the conflicting modes. Still other embodiments will select the lowest quality recording mode of the conflicting modes. Still other embodiments enable a user to determine whether highest quality, lowest quality, or other options, are applied to resolve conflicts. There exist numerous other conflict resolving techniques suitable for use with the invention.

As noted, the present invention is not limited in application to the determination of recording mode, but also is applicable to defining rules governing other device functions, for example, to establish rules that determine when to remove multimedia content from a storage device.

In one arrangement, user defined default recording mode menu selections are provided to a user. Embodiments of the invention include various user operable controls to enable a user to define and manage rules. As used herein, the term “control” includes, but is not limited to, an icon, a button, a radio button, a knob, a text entry field, and any other means representing functions and actions to a user. A variety of controls are known and suitable for use in the invention in accordance with the teachings herein.

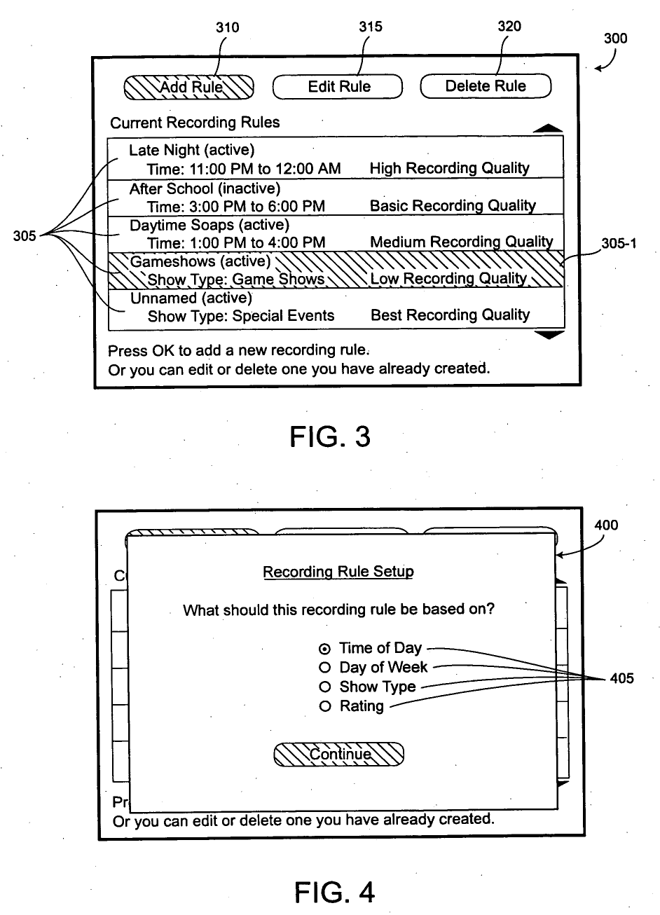

FIG. 3 illustrates one example of a suitable menu 300 for display on a display device. Menu 300 comprises means for a user to define default recording mode rules. Menu 300 comprises an example list portion 305 of comprising user defined default recording mode rules. List portion 305 represents existing default recording mode rules, i.e., default recording mode rules previously defined by a user.

In one embodiment, the menu 300 includes at least one of the following user selectable menu portions on an area of a display. A portion 310 enables a user to add at least one default recording mode rule to existing rules list 305. A portion 315 enables a user to edit existing rules list 305. A portion 320 enables a user to delete at least one rule from existing rules list 305. Other embodiments of the invention include a portion for enabling a user to activate and deactivate at least one rule from existing rules list 305.

FIG. 4 illustrates an example of a menu 400 comprising a list of parameters. In one embodiment of the invention, menu 400 is provided to a user upon user selection of portion 310 from menu 300 of FIG. 3. Menu 400 comprises a plurality of user selectable menu portions 405. Each menu portion 405 corresponds to a different user selectable programming parameter. At least one parameter upon which to base a new rule is selectable by a user. Examples of suitable parameters upon which to base a rule are illustrated at 405. For example, time of day, day of the week, show type, show rating, channel number, channel type, and any other programming characteristic of received programming, comprise suitable parameters for defining default rules.

According to an embodiment of the invention, upon user selection of at least one parameter from menu 400, a menu 500 is provided. Menu 500 comprises at least one user selectable parameter detail portion 505, 510. At least one parameter detail portion 505, 510 enables a user to select specific criteria for applying a rule in accordance with a parameter. For example, for a user-selected parameter “Time of Day,” as shown at 405 of FIG. 4, detail portions 505 and 510 enable a user to select a time of day start time 505 and a time of day end time 510. Other embodiments of the invention are contemplated. For example, according to an alternative embodiment a time line comprising user selectable time blocks is presented to the user.

Another example relates to a user-selected parameter “Day of Week” (405 of FIG. 4.) In this example, menu 500 includes a plurality of user selectable portions, each portion corresponding to a different selectable day of the week. Another example relates to a user selected parameter “Show Type” (shown at 405 of FIG. 4). In that case, menu 500 includes a plurality of user selectable portions, each corresponding to a different program type. Examples of program types include, but are not limited to, genre, and delivery medium (cable, broadcast, Internet, etc). Another example relates to a user selectable attribute “Rating.” (Illustrated at 405 of FIG. 4) In that case, menu 500 includes a plurality of user selectable program ratings portions.

FIG. 6 illustrates a menu 600 including a plurality of user selectable recording mode portions. A user selects a default recording mode 605 to be applied to programs whose parameters match the parameters selected in the previous steps. In one embodiment of the invention, the user selected default recording mode 605 is applied in cases where the user has not made a recording mode selection in conjunction with setting a recording timer. In another embodiment of the invention, a user selectable option to override timer settings for selected rules is provided.

The system associates a recording quality selected from menu 600 with at least one parameter selected, for example via menu's 4 and 5. In one embodiment, the UI presents the recording quality menu 600 after an input parameter has been entered via the input parameter menu 500. In another embodiment, the UI presents the recording quality menu 600 after a control is selected on the rule menu 300. The recording mode menu 600 includes a list of user selectable recording quality levels 605. For instance, the recording quality levels 605 range from low to best. A user selected recording mode 605 is then associated with the parameter selected in the immediately preceding steps, thereby defining a default recording mode rule.

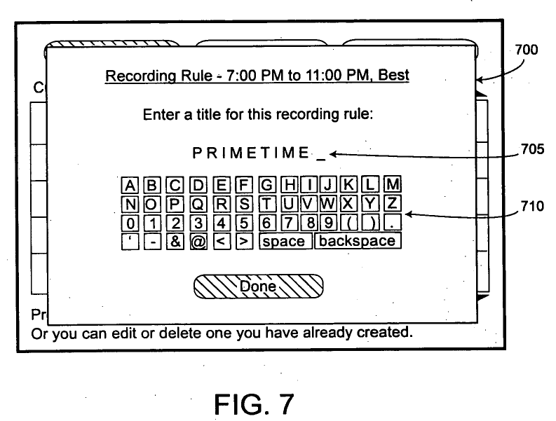

According to one embodiment of the invention, default recording mode rules are named by the user, in order to facilitate subsequent rule management. For instance, in one arrangement, default recording rules are assigned editable rule titles. In one embodiment, a rule title editing menu 700 for adding or editing rule titles is shown in FIG. 7. Title editing menu 700 includes a text entry field 705 for entering and editing rule titles. In one embodiment, a text selection menu 710 also is provided. The text selection menu 710 is useful in the instance that a keyboard is not operatively connected to the multi-media recording device. Characters are selected from the text selection menu 710 using a curser, a keypad, navigation buttons, and any other means that can be used to select characters from a menu of text.

Importantly, the preceding menu systems provide but one example of selecting means by which a user defines default recording mode rules in accordance with the invention. It will be appreciated by those skilled in the art there are a myriad of display screens and menu systems suitable for use in various embodiments of the invention, once the principles of the invention described herein are appreciated.

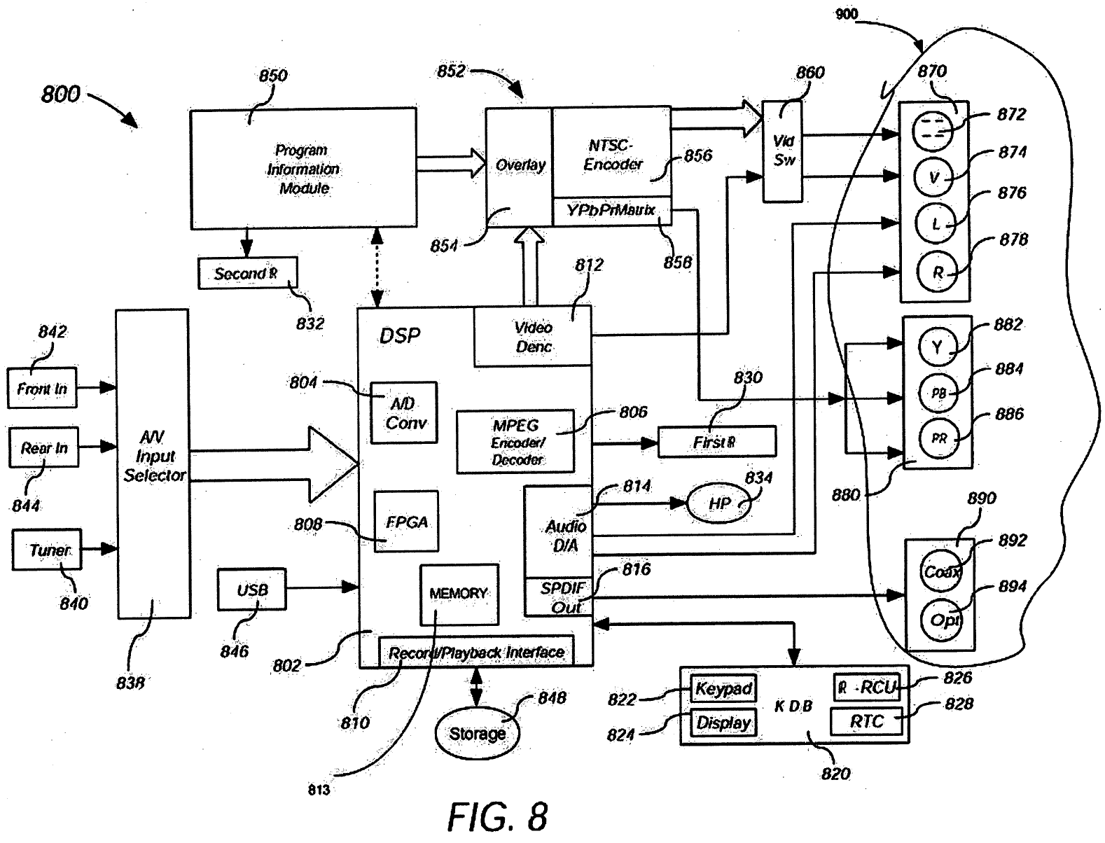

A block diagram of a recording device 800 according to one embodiment of the invention is illustrated in FIG. 8. Device 800 comprises at least a display 900 and a processor 950. Display 800 is operable to display at least one user selectable program parameter. Display 800 is further operable to display at least one user selectable recording mode. Processor 802 is coupled to display 800. Processor 802 associates at least one user selected program parameter with at least one user selected recording mode so as to define at least one user selected default recording mode rule. According to an embodiment of the invention, processor 802 includes a decoder 806 for evaluating incoming program streams to identify programming parameters.

Processor 802 also includes a storage device interface 810 for controlling storage of programming to storage device 848 in accordance with the various embodiments of the invention. For example, processor 802 communicates with storage device 848 such that received programs are recorded at a mode determined by applying at least one user defined default recording mode rule.

According to an embodiment of the invention, device 800 comprises a Personal Video Recording device 800. Device 800 includes a processor for example digital signal processor (DSP) 802, a key and display board 820, a tuner 840, an A/V input selector 838, a USB input 846, a storage device 848 and a program information module 850. Additionally, the PVR 800 includes first and second infra-red (IR) links 830 and 832, a video overlay encoder 852, a video switch 860, a headphone jack 834, a standard A/V component connector block 870, a YPbPr component connector block 880, and a digital interface (SPDIF) connector 890. In one embodiment of the invention, SPDIF 890 is a commercially available Sony/Phillips connector.

The component connectors 870, 880 and 890 provide audio/video signals, including user menus to be displayed, in a variety of output formats. For example, the standard A/V component connector block 870 comprises an S-video connector 872 for outputting to a video display video that has been separated into chrominance and luminance video signals and a composite video connector 874 for providing a standard composite video signal. Further, the standard A/V component connector block 870 includes left and right audio output connectors, 876 and 878, respectively.

The YPbPr component connector block 880 is typically used for displaying high definition television (HDTV), including user menus according to various embodiments of the invention. The YPbPr component connector block 880 comprises a video luminance (Y) output connector 882 for providing an analog video luminance component, a Pb output connector 884 for providing an analog blue color difference (B-Y), and a Pr output connector 886 for providing an analog red color difference (R-Y). Lastly, the SPDIF component connector block 890 comprises a coaxial output 892 and an optical output 894 for outputting digital audio signals via a coaxial cable or fiber optic cable, respectively.

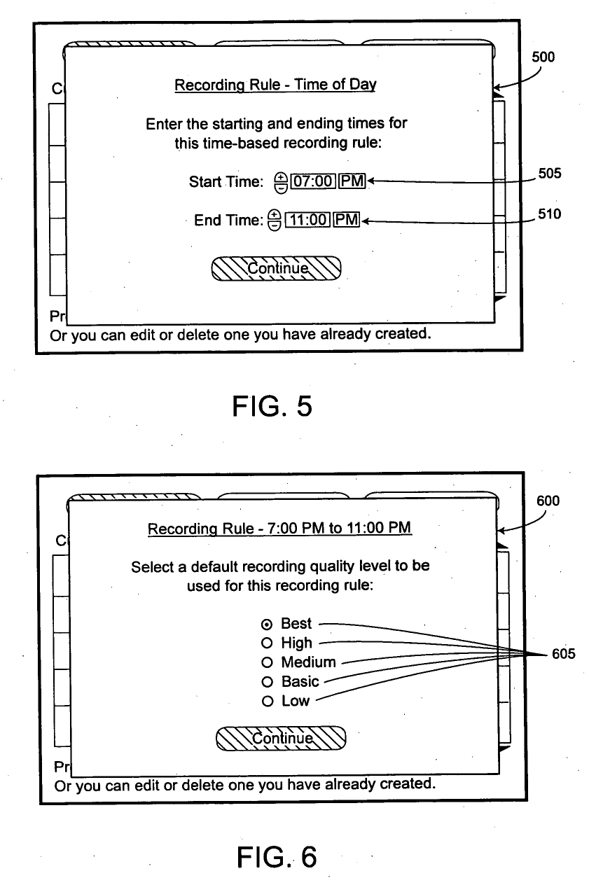

The key and display board 820 is provided as a user interface (UI) for the PVR 800. The embodiment illustrated in FIG. 8 includes a keypad 822, a display 824, an IR remote control interface 826 and a real time clock 828. By using the keypad 822 or the IR remote control interface 826, a user selects user selectable options from menus similar to those illustrated in FIGS. 3-7. Menu options correspond to functions executable by the PVR 800. For example, a user can choose to change channels on the PVR 800 or to perform trick mode playback. The real time clock 828 keeps time, which is shown by the display 824. The display 824 also shows other information as well, for example a trick mode being executed by the PVR 800, a selected channel being recorded by the PVR 800, or an identifier representative of a presentation being shown on a video display.

First and second IR links 830 and 832 form a set of communication links between satellite and non-satellite embodiments of the invention to simplify the interface between the audio, video, and data streams. The first IR link 830 is a communication interface between the DSP 802 and other devices having an IR communication link. Notably, the first IR link 830 is useful for controlling other devices designed specifically for aired or cable television broadcasts or radio broadcasts using standard program guide information. The first IR link 830 also enables features to simplify the consumer's interaction between devices. For example, the first IR link 830 enables one touch program recording, as well as other user conveniences. The second IR link 832 provides an interface between the program information module 850 and other devices having IR communication links. Significantly, the second IR link 832 is useful for communicating with devices not requiring a direct connection to DSP 802, for example with a cable reception device, a VCR, etc.

The DSP 802 executes functions in accordance with, for example, the flowcharts provided in FIGS. 1 and 2 and processes user selections. For instance, the DSP 802 receives user inputs defining parameters and recording modes, and evaluates parameters of received multimedia to apply rules. According to the embodiment shown, DSP 802 includes an analog to digital (A/D) converter 804, an MPEG encoder/decoder 806, a field programmable gate array (FPGA) 808, a recorder/playback interface 810, a video digital encoder 812, an audio digital to analog converter (audio D/A) 814 and a SPDIF output 816. The DSP 802 further includes one or more data busses enabling the different DSP components to communicate with each other and cooperatively process data. Notably, interrupt requests (IRQs) and direct memory addresses (DMAs) are utilized to facilitate bus communications and data processing.

Audio/Video (A/V) input selector 838 includes a plurality of A/V inputs. The A/V input selector 838 forwards the received A/V signals to DSP 802. The DSP's A/D converter 804 is used to convert A/V signals received in an analog format to a digital format. A/V signals already in digital format, for example, digital signals received via a universal serial bus (USB) interface 846, need not undergo the analog to digital conversion.

FPGA 808 provides processing instructions for data received from the A/V input selector 838 or the USB interface 846, depending on the type of data received. For example, if A/V data is received in an uncompressed form, FPGA 808 forwards the A/V data to MPEG encoder/decoder 806 for MPEG compression prior to being sent to the record/playback interface 810. However, if A/V data is received in an MPEG compressed format, FPGA 808 forwards the A/V data straight to the receive/playback interface 810. In either case the FPGA 808 provides read/write instructions to the record/playback interface 810, which then stores the A/V data onto storage 848.

MPEG encoder/decoder 806 performs MPEG compression and decompression on digital A/V signals. For example, MPEG encoder/decoder 806 receives digital A/V signals from A/D converter 804 or USB interface 846, compresses the digital A/V signals using an MPEG format, and forwards the compressed digital A/V signals to the receive/playback interface 810. The receive/playback interface 810 then stores the compressed digital A/V signals to storage 848.

Storage 848 includes at least one data storage device. Suitable storage devices include a magnetic storage medium, such as a hard disk drive (HDD), an optical storage medium, such as a digital video disc (DVD), an electronic storage medium, such as random access memory (RAM), a magneto/optical storage medium, and any combination of storage devices.

For embodiments of the invention including playback capabilities, during playback the receive/playback interface 810 reads A/V data from storage 848. The A/V data then is forwarded to MPEG encoder/decoder 806 for decompression. After decompression the A/V data is separated into video and audio signals. The audio signal is forwarded to SPDIF 816 to be output digitally via coaxial output 892 or optical output 894. The audio signal also is forwarded to audio D/A converter 814 for D/A conversion. After D/A conversion the audio signal is provided to headphone jack 834 and left and right audio outputs 876 and 878.

The video signal is processed by video digital encoder 812, which performs D/A conversion on the video signal as well as encodes the video signal into a variety formats. In one arrangement, the video signal is encoded into an RGB format, separated into luminance and chrominance (Y+C) signals, or encoded into a composite video signal having a National Television Standards Committee (NTSC) format. The composite video and the Y+C video signals are forwarded to video switch 860, while the RGB video signal is forwarded to the video overlay encoder 852.

The video overlay encoder 852 includes overlay module 854, NTSC video encoder 856, and YPbPr matrix encoder 858. The overlay module 854 receives program information from a program information module 850 and graphically overlays the program information onto the video signal. The program information module 850 extracts the program information from a program guide. The program guide is available from a myriad of sources. Suitable providers of the program guide include, but are not limited to, an on-line source, a modem dialup connection, a pager network, etc. In one embodiment the program guide also is contained in incoming A/V signals received by the A/V input selector 838 and communicated to the program information module 850 by the DSP 802.

The program information includes available programs for each channel as well as program scheduling. Further, for each individual program the program information includes a program identifier, channel information, recording time, program duration, scene data, program credits, etc. Other information and graphics are overlayed onto the video signal as well. Typically, information is overlayed on to the video signal when requested by a user or upon some pre-defined event. However, some information, such as a channel identifier, will be continually overlayed over the video signal.

The NTSC encoder outputs the video signal as an NTSC formatted composite video signal, as well as video separated into separate luminance and chrominance signals. The video signals then are forwarded to the video switch 860. The video switch 860 is used to select for display either the NTSC encoded video signal or the video signal generated by the video digital encoder 812. Composite video signals from either source are output via composite video output connector 874, while chrominance and luminance video signals from either source are output via the S-video output connector 872.

The YPbPr matrix encoder 858 generates a YPbPr formatted analog video signal. As previously noted, the YPbPr video signal includes a video luminance (Y) component, an analog blue color difference (B−Y), and an analog red color difference (R−Y). The Y component is output to the Y output connector 882, the (B−Y) difference are output to the Pb output connector 884 and the (R−Y) difference is output to the Pr output connector 886.

While the foregoing is directed to the preferred embodiment of the present invention, other and further embodiments of the invention may be devised without departing from the basic scope thereof, and the scope thereof is determined by the claims that follow.

1. A method of determining a recording mode for a recording device comprising the step of applying at least one user defined default recording mode rule to at least one recording session such that the recording mode for said session is determined by the rule outcome.

2. The method of claim 1 wherein the step of defining comprises the steps of:
displaying at least one user selectable parameter to a user;
receiving at least one user selected parameter in response to the displaying step;
providing a plurality of user selectable recording modes to a user;
receiving at least one user selected recording mode in response to the providing step;
associating said at least one user selected parameter with said at least one recording mode to define at least one default recording mode rule;
recording received programming at a mode determined by applying said at least one user defined default recording mode rule.

3. The method of claim 2 including a step of storing said at least one user defined default recording mode rule in a memory.

4. The method of claim 1 wherein said step of applying said rule is carried out for recording sessions set by timers, wherein said timers lack a timer specific recording mode.

5. The method of claim 1 further including a step of associating user provided labels to respective user defined default recording mode rules.

6. A recording device comprising:
a display operable to display at least one user selectable programming parameter;
said display further operable to display at least one user selectable recording mode;
a processor coupled to said display for associating said at least one user selected program parameter with said at least one user selected recording mode so as to define at least one user selected default recording mode rule;
a decoder coupled to said processor for identifying parameters of received programs;
said processor causing received programs to be recorded at a mode determined by applying said at least one recording mode rule.

7. A method for defining recording quality rules:
receiving a parameter selected by a user;
receiving from a user an indication of a corresponding recording quality mode to be associated with said parameter;
determining recording mode of multimedia to be recorded based upon said parameter selection and said corresponding quality mode.

8. The method of claim 7, wherein said parameter is selected from the group comprising: a time of day, a day of week, a type of show, a show rating, a channel number, and a channel type.

9. The method of claim 7, further comprising the step of providing to the user a menu of selectable parameters.

10. The method of claim 7, further comprising the step of providing to the user at least one menu comprising selectable recording quality modes.

11. The method of claim 7, further comprising the step of providing to the user a user interface for carrying out steps of receiving selections from said user.

12. The method of claim 7, wherein said determining step includes a step of defining at least one rule based upon said at least one user selected parameter and said at least one recording mode.

13. The method of claim 12 wherein recording mode is determined by applying said rule to recording sessions defined by a timer, wherein the timers lacks a timer specific recording mode.

14. The method of claim 7, further comprising a step of presenting parameters to a user via a menu on a display.

15. The method of claim 7, further comprising the steps of:
evaluating recorded multimedia to determine whether the recorded multimedia corresponds to said parameter;
deleting the recorded multimedia if it is determined that the recorded multimedia corresponds to said parameter.

16. A multimedia recording device comprising:
a user interface through which a user enters at least one parameter that identifies multimedia and an indication of a recording mode to be applied when recording multimedia identified by said at least one parameter;
a processor that evaluates at least one parameter associated with received multimedia against a user selected parameter to determine a recording mode for said received multimedia;
a video encoder that encodes the received multimedia using the determined recording mode.

17. The device of claim 16 further comprising a menu, said menu including a list of said parameters, wherein said list comprises parameters selected from the group comprising: a time of day, a day of week, a type of show, a show rating, a channel number, and a channel type.

18. The system of claim 16, further comprising a menu, said menu including a list of selectable recording quality modes.

19. The system of claim 18, wherein said processor generates a rule correlating at least one selected parameter to at least one recording quality mode.
